(19) United States
(12) Patent Application Publication
(10) Pub. No.: US 2014/0136255 A1
(43) Pub. Date: May 15, 2014

(54) Dynamic Task Management

(71) Applicant: WAL-MART STORES, INC., (US)

(72) Inventors: Vadim Grabovski, Fayetteville, AR (US); Lane McKenzie, Rogers, AR (US); Issa Aboud, Rogers, AR (US); John Collier, Rogers, AR (US)

(73) Assignee: WAL-MART STORES, INC., Bentonville, AR (US)

(21) Appl. No.: 13/677,079

(22) Filed: Nov. 14, 2012

(51) Int. Cl. G06Q 10/06

(52) U.S. Cl. CPC G06Q 10/063112; G06Q 10/063114
USPC 705/7.14; 705/7.13

(57) ABSTRACT

Dynamic task management processes and systems are provided, whereby tasks are assigned to workers discretely, in response to worker-originated requests, on a real-time basis. Tasks are extracted from an aggregate thereof, scheduled into one or more queues, then “pulled” by workers for execution. Comprehensive data for performing each task are monitored, as are worker skills and availability. Each task is matched to an appropriate worker, the assignment being adjusted or modified automatically, to the extent required, to satisfy certain predefined temporal and/or spatial criteria. When a worker signals completion of an assigned task, the next discrete task in the queue matching the worker's skills and/or availability is pulled from the queue and assigned. The invention is useful for managing warehouse and inventory operations, and specifically, the scheduling and assignment of pick tasks among warehouse pickers, for example, in connection with e-commerce order fulfillment.

### FIELD

The present invention is directed in general to task management, and in particular, to dynamic processes and systems useful for warehouse and inventory task management.

### BACKGROUND

In the drive to increase the efficiency and profitability of retail operations, improving the management of warehouse and inventory activities is often overlooked.

Among the most time consuming and costly operations in a warehouse is ‘order picking’—an activity that essentially involves the retrieval of items from their warehouse storage locations by “pickers” to fill customer orders. When tasked with a customer order, an order picker travels to and between pick locations, searches for items on the order, retrieve them, and direct them towards further downstream sorting, packaging, and shipping processes.

Picking is often executed by a team, with order items batched into “pick lists” based on some factor (e.g., item location) and assigned to the pickers in “waves”. Each pick list is essentially a “to-do” list and is often arranged to provide what is determined at the moment of its creation to be an optimal schedule for collecting items. Once created, despite the possibility of changing circumstances, the pick list remains fixed.

While wave-based processing has a long history of use in the retail industry, the emergence and growth of e-commerce (i.e., online retailing) has highlighted certain shortcomings.

In contrast with traditional retail operations (i.e., in-store retailing), in on-line retailing, neither the time or location of orders are necessarily fixed. An order from an online customer can theoretically come at any time and from any location. With less predictability in customer orders, the efficient scheduling and formation of waves in a wave-based order fulfillment process becomes increasingly difficult. Expectations of quick order fulfillment, fostered by the ease and immediacy of online shopping, further exacerbate the matter.

Recently, in response to the expansion of online retailing, so-called “waveless” picking processes have been proposed. See e.g., J. Gallien and T. Weber, “To Wave or Not To Wave? Order Release Policies for Warehouses with an Automated Sorter”, Manufacturing & Service Operations Management (Fall 2010), 12:642-662.

Waveless picking involves the continuous transfer of orders for a first queue of incoming customer orders to a second “picking” queue. Pick lists for individual pickers are determined and continually updated in real time from the picking queue. While order fulfillment cycle times can be affected by such waveless methodology, the common use of imprecise pick lists comprising un-decomposed orders continues to challenge efficiency. Need thus remains for alternative techniques and strategies suited for more flexible, responsive, and discrete task management and for achieving good worker-to-task correlation.

By many estimates, in large retail operation, warehouse picking can account for greater than 50% of the time and costs of customer order fulfillment. Clearly, simplifying and streamlining the picking process—or similar worker-assignable warehouse or inventory activity—could yield significant improvements to the operational expense of any retail operation.

### SUMMARY

In light of the above need, the present invention provides dynamic task management processes and systems capable of discretely assigning tasks to workers, in response to worker-originated requests, on a rolling real-time basis. The invention is useful for managing warehouse and inventory operations, and specifically, the scheduling and assignment of pick tasks among warehouse pickers, for example, in connection with e-commerce order fulfillment.

According to the invention, discrete individual tasks are extracted, scheduled into one or more queues, then “pulled” by workers for execution. Comprehensive data for performing each task are monitored rigorously, as are the skills and availability of each worker. Each task is matched specifically to an appropriate worker on a rolling real-time basis, the assignment being adjusted or modified automatically, when and to the extent desired, to satisfy certain pre-defined temporal and/or spatial criteria. When a worker signals completion of an assigned task, the next discrete task in the queue that matches appropriately the worker's skills and/or availability is pulled from the queue and assigned to the worker.

It is a principal object of the present invention to provide dynamic task management processes and systems.

It is another object of the present invention to provide task management processes and systems, where discrete task-to-worker assignments are a function of comprehensively collected and processed data relating to individual tasks and individual workers.

It is another object of the present invention or provide dynamic warehouse and inventory task management processes and systems capable of performing discrete, real-time, high-correlation task-to-worker assignments.

It is another object of the present invention to provide a dynamic task management system capable of automatically influencing worker-to-task assignments based on temporal and/or spatial criteria, such as due times and worker travel distances.

It is another object of the present invention to provide an improved “waveless” pick task management process and system capable of responsive, highly-resolved, real-time tuning of pick task schedules and assignments.

It is another object of the present invention to provide a dynamic warehouse task management process that enables discrete scheduling of tasks to warehouse pickers, simplifying the picking process, and thereby enabling warehouse operation at a lower potential labor cost.

For a further understanding of the nature and objects of the invention reference should be had to the following description taken in conjunction with the accompanying drawings.

### BRIEF DESCRIPTION OF THE DRAWINGS

FIG. 1 illustrates schematically a dynamic task management process 10 according to an embodiment of the present invention.

FIG. 2 illustrates schematically a dynamic task management systems 100 according to an embodiment of the present invention.

FIG. 3 illustrates schematically the extraction of tasks from incoming orders 24a, 24b, and 24c into master task sequence 26.

FIG. 4 illustrates schematically the assignment of a discrete task from a master task sequence 26 to a worker 20, both indirectly (A) and directly (B).

FIGS. 5A and 5B illustrate schematically worker travel routes through a warehouse 300 following route-unordered and route-ordered master task sequences 26, respectively.

FIGS. 6A and 6B illustrate schematically the assignment of tasks in master task sequence 26 to workers 20 without and with the influence of time-based “load balancing”, respectively.

### DETAILED DESCRIPTION

The present invention encompasses processes and systems for dynamically and discretely managing tasks performed in retail facilities (particularly, in the warehouses thereof) by the facilities' workers (particularly, by warehouse pickers). Tasks are received at a facility from one or more sources; then sorted, scheduled, and assigned to workers with broad flexibility, and in a manner that reduces delay, promotes a more economic allocation of labor resources, and simplifies task performance.

In particular, discrete individual tasks are extracted from one or more sources (such as orders received from an e-commerce retail website), then scheduled into one or more queues, and then “pulled” by workers from the queue for execution. Comprehensive data for performing each task are monitored rigorously, as are the skills and availability of each worker. Each discrete task is matched specifically (i.e., “personalized”) to an appropriate worker on a rolling real-time basis, the assignment being adjusted or modified, when and to the extent required, to satisfy certain temporal or spatial criteria (e.g., time and route optimization). When a worker signals completion of an assigned task, the next discrete task in the queue that matches appropriately the worker's skills and/or availability is pulled from the queue and assigned to the worker.

As will be evident to those skilled in the art, the invention is unique in its capacity to perform a fine degree of task management (e.g., real-time streaming of “tasks” vs. real-time streaming of “batches”), as well as in its “pulling” of personalized task information by workers, rather than the common conventional practice of “pushing” predefined orders thereto.

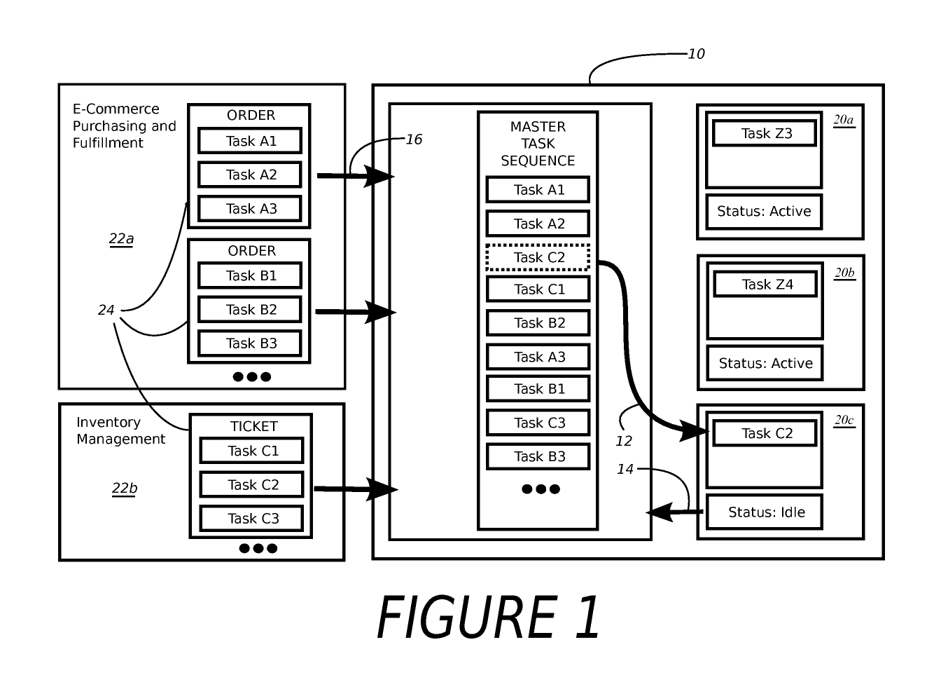

As a methodology, the invention is embodied preferably as a dynamic warehouse task management process for scheduling and assigning picking tasks to workers (i.e., “pickers”) in a warehouse. The warehouse tasks (e.g., picking, restocking, unloading, and tracking) typically originate from one or more task-generators (e.g., online purchasing and fulfillment facilities, inventory management systems, etc.) and are executed in a warehouse by a team of pickers of varying skills, qualifications, and experience. As illustrated schematically in FIG. 1, the management process comprises several steps, which—in typical high-volume commercial practices employing high-speed digital communications, processors, and databases—will often be performed contemporaneously in a virtually seamless and continuous rate, thus achieving an “always on” presence.

According to the process, the status of each of the pickers 20a, 20b, and 20c employed at the warehouse is monitored, the picker status for each including the picker's location in the warehouse, the picker's qualifications (e.g., skills, restrictions, certifications, etc.), and the picker current activity (e.g., “active”, “idle”, “on break”, etc.). When an “order” (or “task set”) 24—defined herein as any communication expressly or implicitly containing a requisition to a worker to perform one or more inventory-related tasks—is received from a task generator 22a, the order 24 is decomposed into its constituent tasks A1, A2, A3. In other words, one, some, or all tasks are extracted from the order. Typically, multiple orders are received; and all tasks contained therein extracted.

A task code-set for each of the extracted tasks is then defined, the task code-set including, but not limited to, a priority code (e.g., a deadline), a product/service classification (e.g., electronic, apparel, fungible, regulated, etc.), and a location code (e.g., zone, aisle, shelf, bin, etc.). Finally, the extracted tasks are assigned discretely (without aggregation into batches or waves) to individual pickers 20a, 20b, and 20c in response to implicit or express task requests 14 received from the pickers, the task assignments being matched electronically to pickers as a function of both (a) the picker's status and (b) the task's code-set.

As a system, the invention is embodied preferably as a dynamic warehouse task management system useful for mediating the exchange of task-related information between a task generator and a task performer (i.e. a worker).

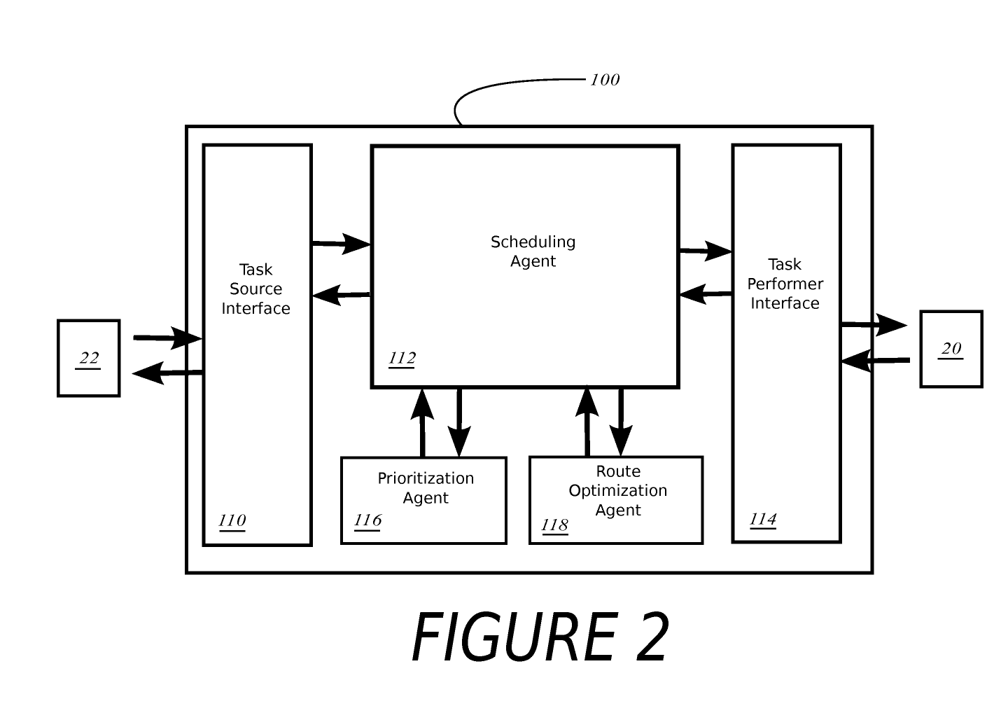

As illustrated schematically in FIG. 2, the management system comprises a dynamic task manager 100 (typically, located onsite at a warehouse or other retail outlet), which in operation remains in constant communication with a portable digital device (typically hand held by the task performer, or otherwise mobile).

The dynamic task manager 100 comprises a task source interface 110, a scheduling agent 112, a prioritization agent 116, a route optimization agent 118, and a task performer interface 114. The task source interface 110 functions to receive task sets from the task generator 22. The scheduling agent 112 functions to create a master task sequence from the incoming task sets received at the task source interface 110. The scheduling agent 112 is configured and in communication with both the prioritization 116 and route optimization agents 118, such that the prioritization agent 116 can influence the scheduling of the task within the master task set as a function of time-based requirements and the route optimization agent 118, likewise, can influence the ordering as a function of distance-based preferences.

The task performer interface 114 functions to transmit a personalized task to the task performer 20 in response to the receipt of an express or implied task request from the task performer. The personalized task being “personalized” at extraction by the dynamic task manager 100 as a result of matching a task from the master task sequence to information (e.g., about a task performer) embedded in, extrapolated from, or otherwise associated with the task request.

The portable digital device is configured both for mobility and for bilateral digital communication with the dynamic task manager, i.e., through the task performer interface 114. The portable digital device functions—among other capabilities used in the course of discharging one's duties—to transmit task requests to the task performer interface and to receive the personalized task assignments that are sent back in response.

As indicated above, an “order” (or “task set”) is an express or implied requisition, ultimately directed to a worker, to perform one or more tasks. An example of an “order” is a “service ticket” generated manually by a manager, or automatically by inventory management software, expressly requesting a worker (or workers) at a warehouse to perform an inventory count of a particular product or SKU, or to restock certain shelves or bins, or to unload an incoming shipment at a particular docking zone. Another example is a “purchase order”, generated online through a retail website or other e-commerce portal, expressly requesting delivery of purchased “item(s)”, and thus, implicitly requiring the retrieval by “pickers” of the item(s) from inventory (in addition to other upstream and downstream order fulfillment tasks).

An “order” can comprise one broad task (e.g., receive shipment) or several related narrow tasks (e.g., meet carrier at loading dock, scan contents of shipment, unload shipment, release carrier, transfer shipment to inventory). By decomposing a broad task into appropriately narrower specific tasks, it is possible with the present invention to guide less experienced workers through complicated operations.

When received from a task-generator 22, it is not required necessarily in all instances that the “order” be unprocessed, “untouched”, or otherwise unmodified by upstream intake processes prior to intake under the present invention. For example, in many ecommerce portals, the customer interface is typically designed to create a user-friendly experience. Accordingly, the raw input (e.g., a product name and model) from an on-line customer will rarely be sufficient itself to enable timely and accurate order fulfillment. Other data is needed. As such, e-commerce facilities may in the intake process associate and supplement the raw online customer input with further data, such as product SKU, location, class, and the like. Such data can, of course, be used in the present invention, for example, when “code-sets” are “defined” for “extracted tasks”. Additional upstream processes can include the filtering, compiling, merging, sorting, collection, collation, and distribution of orders.

While the present invention encompasses processes and systems receiving tasks from multiple task-generators, it is particularly well suited for use in the fulfillment of orders generated by an e-commerce retail facility. In contrast to traditional orders and product requests generated through so-called “brick-and-mortar” retail and catalog-based mail-order activities, e-commerce purchase orders—particularly for large global companies—can be generated at any time or day of the week and can entail vast breadth and variance in order size, customers, product range, and the like. The immediacy of online transaction also lends to elevated customer expectations for quick and accurate fulfillment and delivery. By employing the present invention, inventory-related tasks can be scheduled on a continuous streaming basis, without the periodicity of so-called “batching” and “wave”-based processes. Moreover, by discretely matching and assigning tasks to specific inventory workers, improvement in accuracy can be realized.

Aside from e-commerce facilities, another example of a task-generator would be, as mentioned hereinabove, an “inventory management system” (also know as an “inventory control system”). An inventory management system is a set of hardware of software based tools that automate the process of tracking inventory. The kinds of inventory tracked with an inventory management system can include almost any type of quantifiable good, including food, clothing, books, equipment, and any other item that consumers, retailers, and wholesalers may purchase. Inventory management systems typically work in real time to electronically transmit information immediately to and from a central computer as buying, selling, and shipping transactions occur.

It will be appreciated that inventory management systems—especially for global retailers such as Wal-Mart Stores, Inc.—can be massive in their functionality, scale, and deployment. Record keeping, inventory tracking, and logistics will, in respect of activity (cf., “bandwidth”), likely predominate other functions, such as the assignment of tasks to workers. Nonetheless, for the present invention, inventory management systems are an expected and likely source of “tasks” (as defined herein). Physical inventory counting and cycle counting are examples of such “tasks”.

It will also be appreciated that, although “inventory management systems” and “e-commerce retail facilities” are discussed herein as separate entities, it not uncommon in practice that two are enmeshed, merged, interlinked, interconnected, or fully and seamlessly integrated. Separate or united, they (or it) remain “task generators”.

Contemporaneously with “listening” for incoming tasks from task generators, the invention also maintains active electronic “awareness” of or otherwise monitors status information generated by and relating to the workers employed to perform those tasks. Basic status information includes location, qualifications (e.g., skills, grade level, certifications, licenses, etc.), and—most importantly—current work activity.

Several means are available for monitoring status information. For example, a system may employ a local computer network (i.e., at a warehouse) with several local wireless nodes and WAN access to larger computer facilities hosted remotely offsite at, for example, a corporation's global or regional headquarters. In such a system, certain worker status information (i.e., those that tend to be static, such as “skills” and “certifications”) can be entered and stored at a data center; while other status information (i.e., those that tend to be ephemeral, such as “location” and “current activity”) can be tracked locally (e.g., through the use of handheld scanning devices that transmit and receive information to and from the local computer network through its wireless nodes). Preferably, in the course of executing task scheduling and assignment algorithms, the transmission of ephemeral status information will call automatically for, and thus be supplemented with, the stored status information, thereby improving considerably task-to-worker matching.

The frequency and degree to which worker status information is monitored will vary depending on the means employed. For comparatively small operations, the monitoring of only a few fields of basic status information may be desirable. By hosting this information locally, network and system bandwidth requirements can be reduced, and monitoring executed more frequently. In contrast, for larger operations, more comprehensive status information may be appropriate. Where several fields of Information are employed, distributing and sharing the information among local and remote resources may be desirable. For such, the frequency of monitoring can be throttled down to accommodate the comparatively larger system and bandwidth requirements.

The particular types of status information is also variable, and likely will be a function of an inventory's product profile.

Nonetheless, in respect of “location”, examples of status information particularly relevant to warehouse task management, include: “Zone”, “lane”, “aisle”, “area”, “building”, and “floor”. Such information can be tracked as a warehouse picker performs his assigned tasks by, for example, equipping him with a handheld scanner device with location detection functionality, or more simply, by placing location tags throughout the warehouse that the worker can scan and upload to a task manager. For certain warehouse operations, product labels may be sufficient alone to provide location data, rendering unnecessary separate location tags.

In respect of “qualification”, examples particularly relevant to warehouse inventory tasks, include: “Skills”, “grade level”, “certifications”, and “licenses”. “Grade level” may be relevant, for example, in assigning more complex or critical picking tasks to pickers with greater experience or seniority. “Certifications” and “licenses” may be relevant, for example, in assigning task involving the operation of a forklift (which may requiring a forklift driver certification and/or license), or involving the handling of alcoholic beverages (which may require an age certification), or involving physically strenuous activity (which may require a medical certification). “Skills” may be relevant, for example, in assigning tasks requiring a particular expertise (cf., foreign language skills, advanced computer skills, packing and shipping skills, basic math skills, etc.).

In respect of “current activity”, regardless of the variety of nomenclature or tags available for code activities (e.g., “active”, “inactive”, “pending”, “on break”, “idle”, “awaiting task”, “tasked”, “engaged”, “unassigned”, etc.), it is important that information regarding whether or not a worker is ready for a next assignment be quickly and regularly communicated to the task manager. This can be accomplished manually by a worker, for example, by requiring him to transmit a work request to the task manager when he becomes available for additional tasks. More preferably, however, status updates are accomplished automatically once a previously assigned task is assigned or completed. Completion of a picking task, for example, can be reported to a task manager instantaneously once labels on both a picked item and the tote in which it is placed are scanned. With the prior task completed, it can be deleted from a master task schedule and the worker's status information updated to “awaiting task” (or the like).

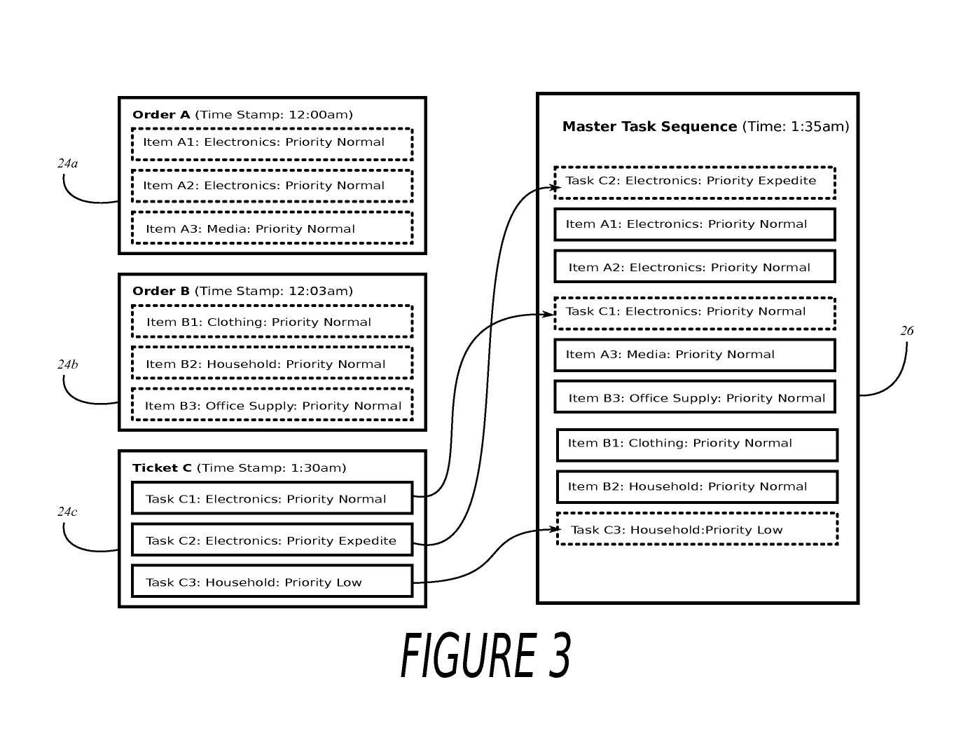

As illustrated in FIG. 3, orders 24a, 24b, and 24c—each containing several discrete tasks—are received from task generators at different times. As they arrive, the individual tasks are extracted and queued into a master task sequence 26. The queue is subject to change as further discussed below, but nonetheless, ready for assignment to workers.

More particularly, order 24a—representative of a purchase order received from an online retail facility—is time-stamped 12:00 a.m. and includes three implied tasks: i.e., the picking of item A1, item A2, and item A3 from warehouse inventory. Order 24b—also representative of an online order—is received later at 12:03 a.m. and also includes three implied tasks: i.e., the picking of item B1, item B2, and item B3. Ticket 24c—representative of a service request received from an inventory management system—is received at 1:30 a.m. and includes three tasks: i.e., task C1, task C2, and task C3. All of the tasks in FIG. 3 have “normal” priorities, with the exceptions of task C1 (which has an “expedited” priority) and task C3 (which has a “low” priority).

The “snapshot” of the master task sequence 26 is taken at 1:35 a.m. Hence, the tasks contained in orders 24a and 24b have already been extracted and placed into queue. At 1:30 a.m., ticket C is received and, without waiting for additional orders, is immediately processed: i.e., tasks C1, C2, and C3 are extracted and placed into the master task sequence 26.

Scheduling—discussed in further detail below—is apparent in FIG. 3. Task C2 (having “expedited” priority) is placed on the top of the queue; task C3 (having “low” priority) is placed at the bottom. Similarly, tasks likely to be performed in the same areas of a warehouse inventory (cf., “electronics) are grouped together, reducing travel time between work zones.

Although not particularly detailed in FIG. 3, for each task extracted from an order, a “code set” is defined. Comparable to the status information for workers, the “code set” provides information about the task. The information contained in the task “code set” can be quite comprehensive, but in the preferred mode of practicing the inventive methodology, should include at least a “priority code”, a “product/service classification”, and a “location” code.

As used herein, a “priority code” is any information representative of a temporal parameter, or other variable capable of influencing the scheduling of a task. Examples include: time-stamps; deadlines; priority codes (e.g., “urgent”, “immediate”, “low”); SLA (“Service Level Agreements”) reference (i.e., to the extent such agreements may call for “rush” orders” or “expedited delivery”; and common carrier codes (i.e., to the extent that certain common carriers may impose deadlines to meet their delivery requirements).

As used herein, a “product/service classification” is any information capable of providing or describing any feature, character, identity, or class of the product(s) or service(s) involved in a task. Examples include: Brands and names; class of goods (e.g., electronics, media, apparel, household, food, etc.); SKUs, serial numbers, and model numbers; weight and dimensions; environmental requirements (e.g., frozen, dry, ambient, etc.); and shelf life (e.g., expiration dates).

Finally, as used herein, a “location code” is any information capable of providing or describing the location of a product or a service involved in a task. Examples include codes for particular “zones”, “lanes”, “aisles”, “shelves”, bins, “area”, “buildings”, or “floor” of a warehouse facility. It is possible also that the “location code” can be the same as a “product/service classification”. For example, the code “electronics” may serve as both its “product/service classification” (i.e., the product belongs to the category “electronics”) and its “location code” (i.e., the product is located in the “electronics” zone of the warehouse).

The assignment of task to workers relies on the tracking of discrete task code sets and the monitoring of discrete worker status information. Codes sets are defined for each task. Status information is monitored for each worker. When task assignments are performed, it is done so with task-to-worker matching made a function of both (a) a worker's status information and (b) a task's code-set.

For instance, assume two warehouse pickers, having completed their prior tasks, become available for new task assignments at 1:40 a.m. and 1:42 a.m., respectively. The first picker has the following status information: [(activity, “available”), (experience, “new hire”), (location, “household”). The second picker has: [(activity, “available”), (experience, “senior”), (location, “electronics”)]. At 1:30 a.m., the ticket 24c illustrated in FIG. 3 is received. At 1:35 a.m., task's C1, C2, and C3 are extracted and placed into master task sequence 26. When the first picker become available at 1:40 a.m., he is considered for the assignment of task C2, which is the first task in the queue, and which hypothetically may have the following “code set”: [(priority, “expedite”), (classification, “c2”), (location, “electronics”)]. The assignment, however, does not provide good matching with regard to worker-task location and priority-experience. Thus, the first picker is assigned instead to task C3, which hypothetically should have better location and priority-experience matching. When the second picker becomes available at 1:42 a.m., he is better matched to and is thus assigned leading task C3. Clearly, the assignments above are performed not only on a discrete real-time basis, but also with good worker-to-task correlation.

To prevent overwhelming a worker with batches of task assignments—as well as promote an orderly, timely and metered distribution of tasks among a team of workers—task assignments are performed only when prompted by a “task request” transmitted by a worker. This assure that, prior to an assignment being made, there is a check to determine whether the worker is in fact available to perform a new task. If unavailable, assignment passes that worker and is directed to one that is in fact available.

The task request need not be explicit. In the preferred methodology, the task request is implied from the worker's “status information”. For instance, task completion can be signaled through a worker's handheld digital device, for example, upon scanning a label on a product or tote, or upon manually “checking off” a task entry appearing on the device's display. The worker's status is then changed from “active” to “available”, and thus, a new task assignment is requested.

Preferably, the practice of the inventive methodology is performed using, as mentioned above, a dynamic task manager having a task source interface, a scheduling agent, a prioritization agent, a route optimization agent, and a task performer interface.

The scheduling agent functions to create a master task sequence from incoming tasks received at the task source interface. It is from the master task sequence that tasks are pulled for assignment to workers. The master task sequence can remain unchanged throughout several task-to-worker assignment iterations or, more preferably, dynamically sorted and re-sorted as task requests are received, assigned, and executed.

The scheduling agent can incorporate, be linked to, or otherwise be associated with other functionalities that enhance or affect the sorting and resorting of tasks. Examples include, but are not limited to a task matching agent, a policy enforcing agent, and an activity metrics monitor. The task matching agent could implement the algorithms and protocols driving or otherwise enhancing task-to-worker assignment. The policy enforcing agent could be used to monitor and/or assure compliance with predetermined operating policies, for example, by providing appropriate weighting to tasks that are subject to certain “service level agreements”. The activity metrics monitor can be implemented to collect and process data relating to task assignments and the execution thereof, the data capable of being used as feedback for further influencing the operation of the dynamic task manager.

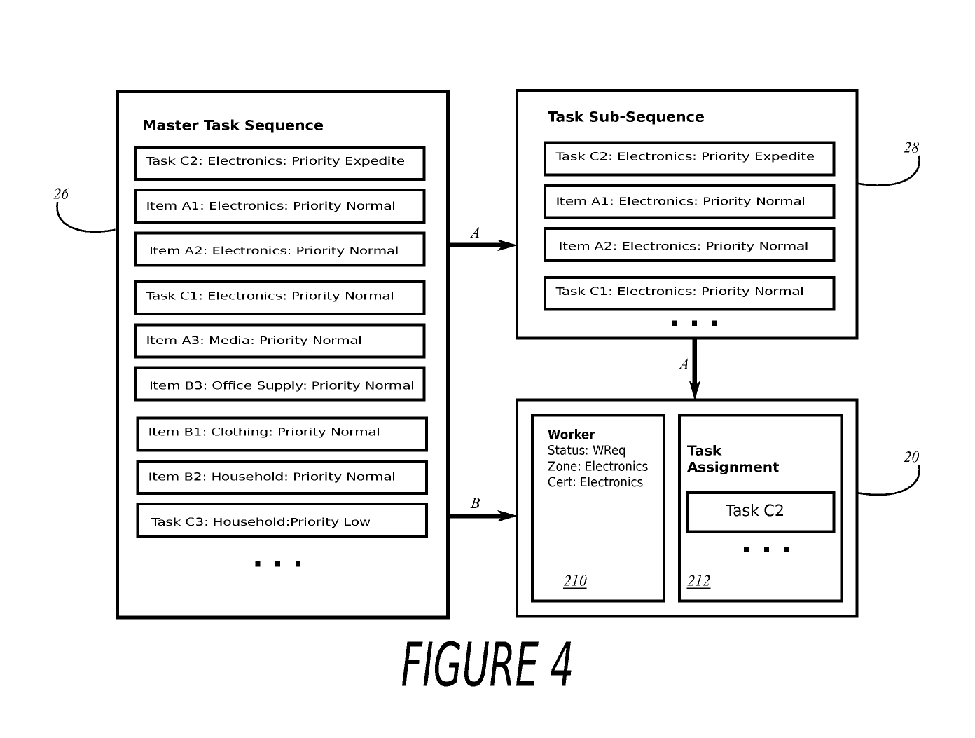

As shown in FIG. 4, assignment can either be pulled directly from the master task sequence 26 to the worker 20 (i.e., method “B”), or indirectly through task sub-sequence 28 (i.e., method “A”).

In particular, in method B, upon receiving a task-request from worker 20, worker-to-task matching algorithms operating in the dynamic task manager use pointers that lead directly to the data structures embodying master task sequence 26. Thus, all task included in the master task sequence 26 are potentially assignable to worker 20's personal task sequence 212. However, for certain scenarios, such as those requiring greater security, or those having tighter resource and bandwidth constraints, dividing the master sequence to sub-sequences at or around the time of assignment may be desirable.

As such, in method A, upon receiving a task-request from worker 20, the dynamic task manager notes certain information contained in worker 20's status information 210 (e.g., [(zone, “electronics”)] and creates a sub-sequence 28 that includes only those tasks with the master task sequence that matches that information. Thus, task sub-sequence 28 comprises tasks C2, A1, A2, and C1, each presumptively having the task-code [(zone, “electronics”)]. Subsequently, assignment is performed with a pointer directed towards the sub-sequence 28, instead of the master sequence 26.

In the creation of master task sequence 26, the scheduling agent can also be influenced by a route optimization agent. For example, the agent can be configured to use location specifying information contained in task code-sets and relate it to mapped location information stored at or accessible by the dynamic task manger to determine the shortest or quickest routes from one or several task location to others. By applying appropriate weights or grades to various alternative pathways and/or location, using well-known algorithms and heuristics, tasks can be reordered within a master task sequence as a function of distance-based preferences.

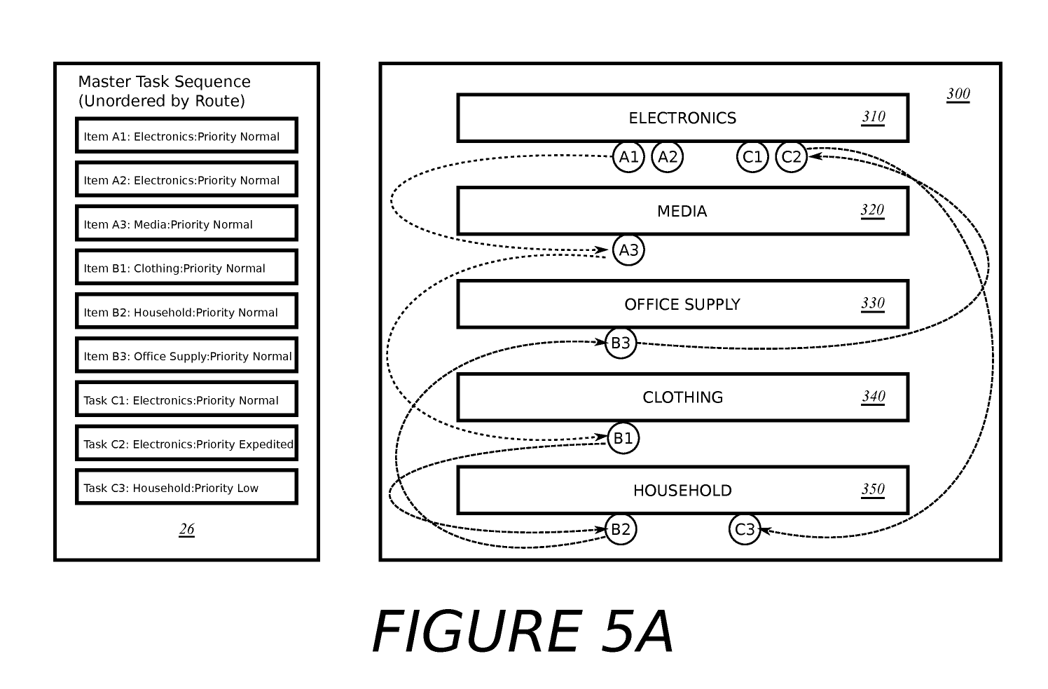

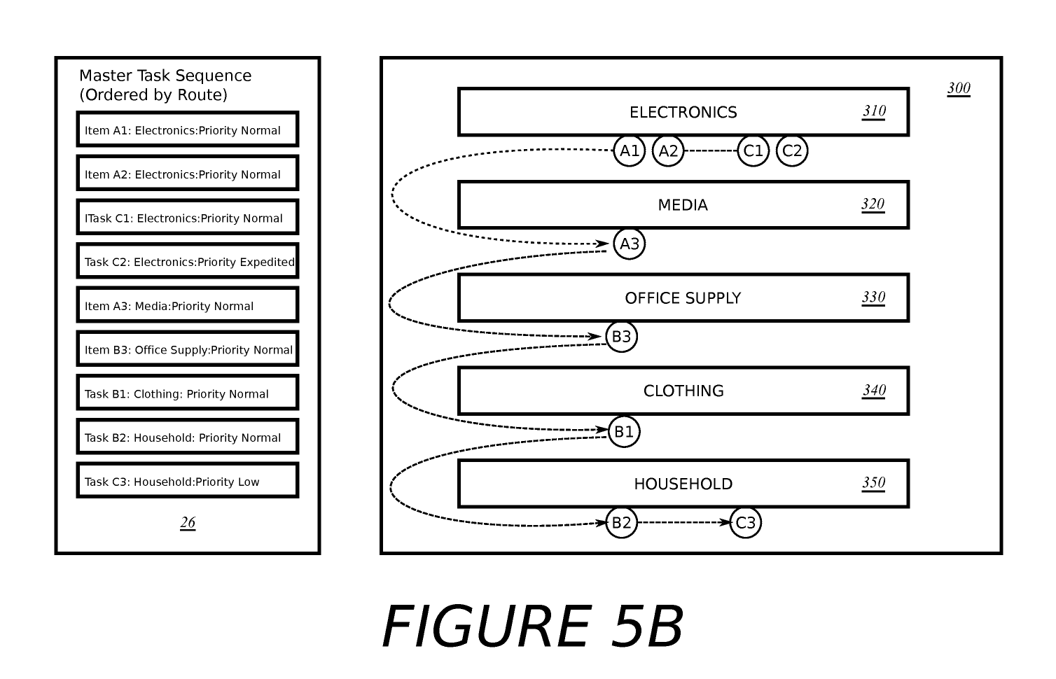

By way of illustration, FIGS. 5A and 5B shows the differences in work routes following master task sequences 26, with and without the influence of a route optimization agent.

In FIG. 5A, master task sequence 26 comprises a schedule of tasks A1-C3 arranged in the order in which they are chronologically received. If the tasks on this schedule are assigned sequentially to a single worker, the path taken by that worker through warehouse 300 to perform each task at the respective inventory shelves 310, 320, 330, 340, and 350 would be comparatively circuitous, involving back tracking and longer and more frequent aisle hopping.

In contrast, in FIG. 5B, the schedule of tasks in master task sequence 26 is arranged under the influence of a route optimization agent, not as received chronologically. The difference is quite noticeable. The path shown in FIG. 5B involves no back tracking and only four hops between immediately adjacent shelves, i.e., between shelves 310 and 320, between shelves 320 and 330, between shelves 330 and 340, and between shelves 340 and 350. Clearly, the overall distance in FIG. 5B is shorter than that of the route illustrated in FIG. 5A.

Distance is not the only variable useful in determining the sequence of tasks in a master task sequence 26. Time-based (“temporal”) prioritization is also important.

Although it is within the scope of the present invention to schedule tasks in the order in which they are received (i.e., FIFO), the urgency for completing any particular task will often vary regardless of when that task was received. Accordingly, a prioritization agent is used in the dynamic transfer manager to influence the ordering of incoming task sets as a function of a time-based requirement for performance of at least one (but likely all) tasks within the set.

In one embodiment, the prioritization agent affects scheduling within a master task sequence utilizing the “priority code” in a task's “code-set” (e.g., by using an algorithm that compares and gives appropriate weight to the priority codes of two or more extracted tasks). Thus, as exemplified in FIG. 3, a task bearing a priority code “expedite” (i.e., task C1)—though contained in a later-received task set (i.e., task set 24c)—is given a higher priority over less urgent tasks (i.e., tasks A1, A2, A3, B1, B2, and B3) extracted from earlier-received task sets (i.e., task sets 24a and 24b).

Chronological ordering based only on priority codes may not in all circumstances be sufficient. If not distributed among workers appropriately, deadlines for performing tasks may be missed. Thus, in another embodiment, the prioritization agent is configured with the further capacity to assess the schedule of tasks within a master task sequence and distribute them among workers to meet time constraints that would otherwise be exceeded. Load sensing and load rebalancing programs and algorithms—known in the art—can be implemented and/or referenced to provide this capacity

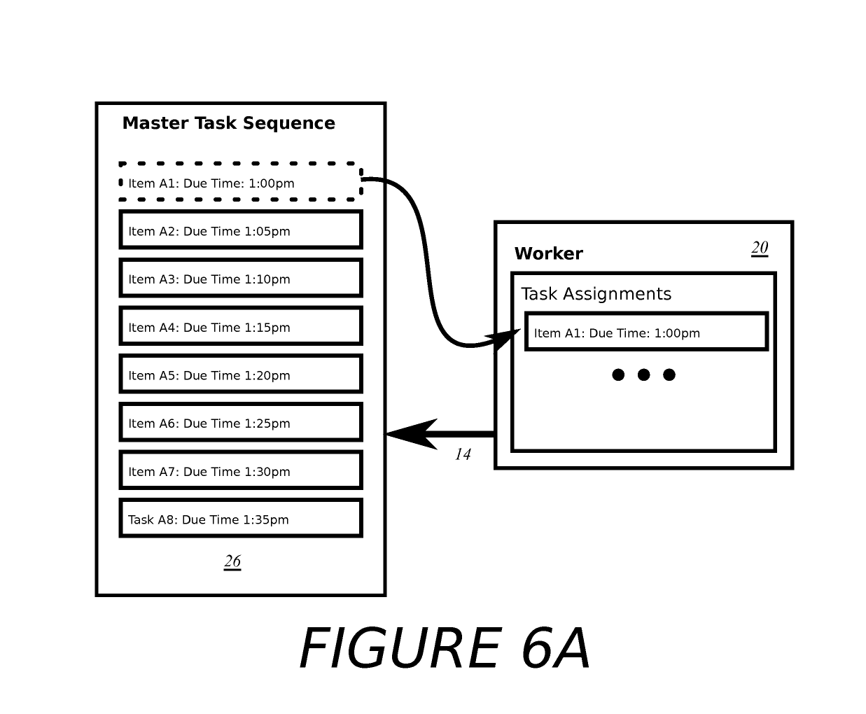

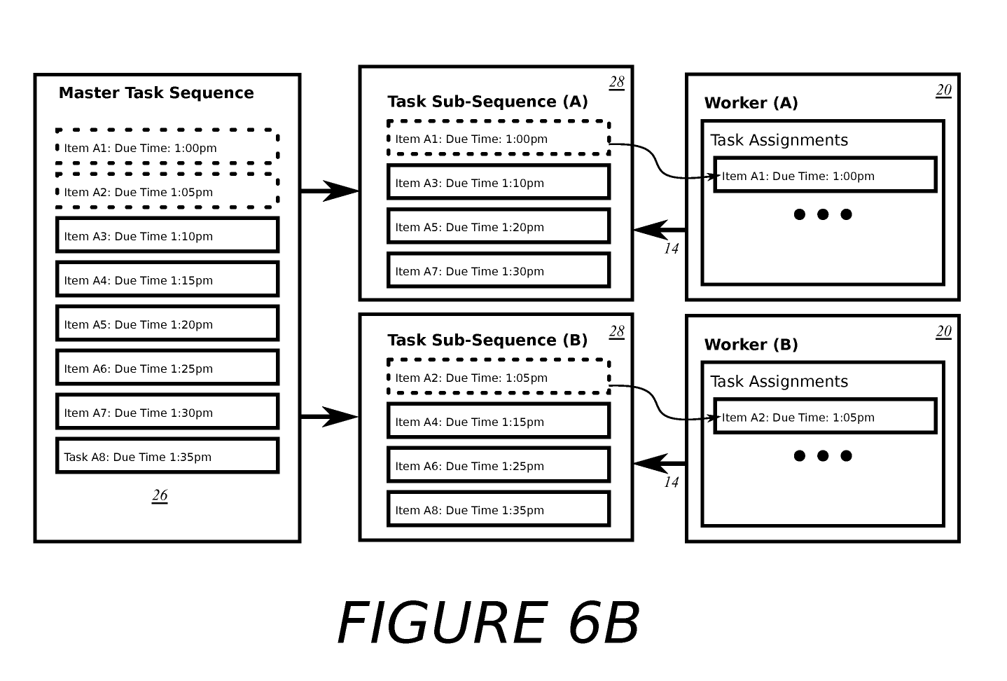

By way of illustration, in FIG. 6A, master task sequence 26 contains eight items A1 to A8, ordered chronologically according to their due times. Item A1 is due at 1:00 p.m., with the remaining items following sequentially at 5 minute intervals, the last item A8 being due at 1:35 p.m. If each of the tasks were sequentially assigned to a single worker 20 (i.e., as prompted by a corresponding sequence of task requests 14), assuming worker 20 starts at 12:30 p.m. and that each task requires 10 minutes, then the deadlines for items A6, A7, and A8 will all be missed. Work on item A6 would commence at 1:20 p.m., and finish five minutes late at 1:30 p.m. Work on items A7 and A8 will commence already past due.

To better meet time requirements, as shown in FIG. 6B, a prioritization agent can be used to effect a division of the master task sequence 26 into two task sub-sequences 28(A) and 28(B), from which individual tasks are assigned sequentially to two workers 20(A) and 20(B), respectively. Using the same assumptions above—i.e., work commences at 12:30 p.m. and each task requires 10 minutes—all tasks will be completed with several minutes to spare.

It will be appreciated that efficacy of the prioritization agent—as well as the route optimization agent—will rely in large part on the quality of the worker status information monitored by the dynamic task manager. Ephemeral information—such as worker location (important for route optimization) and current activity (important for prioritization)—will likely be channeled into the dynamic task manager wirelessly using a handheld or otherwise portable digital device.

With regard to its basic functionality, the portable digital device is configured to transmit task requests to the dynamic task manager through it task performer interface and, in response, receiving a personalized task assignment. Any of the several types of handheld, wearable, and/or mobile digital devices now currently available can be used for this purpose, provided they are appropriately portable (particularly when performing the tasks at issue) and capable of digital communication with the dynamic task manager through its task performer interface—preferably, in real-time and wirelessly. Other functionality and features would include optical or electromagnetic readers (for reading bar codes, RFID tags, product labels, and like information-bearing media), triangulation, global positioning, a magnetic stripe reader, a capacitive signature interface, a touch screen display, and a printer for printing labels and tags. Examples of portable digital devices include, but are not limited to, handheld RFID scanners, optical bar code scanners, personal digital assistants, smart phones, digital notebooks, and digital tablets.

Adequate portability can be achieved using fixed or dockable digital devices, provided those devices are fixed or dockable on a mobile platform. For example, digital tablets and notebooks can be mounted on a cart, forklift, cherry-picker, or buggy used by the worker. The worker interface for such vehicle-mounted devices can be a keyboard or touchpad, or a voice-command interface using headphones and a microphone, or other type of human-to-device interface.

Although certain embodiments of the invention are described, those skillful in the art, having the benefit of the teachings herein, can effect numerous modifications thereto. These modification are to be construed as encompassed within the scope of the present invention as set forth in the appended claims.

1. A dynamic task management process for scheduling and assigning tasks that originate from one or more task-generators and are executed by a team of workers, the dynamic task management process comprising the steps of:
monitoring the status of each of said workers, the worker status for each including a worker location, a worker qualification, and a worker current activity;
receiving an order from one of said task-generators, said order including one or more tasks;
extracting from said order at least one of said tasks;
defining a task code-set for each of said extracted tasks, the task code-set for each including a priority code, a product/service classification, and a location code;
assigning one of said extracted tasks to one of said workers in response to a task request received from said worker, said assignment being a function of both (a) said worker status and (b) said task code-set.

2. The dynamic task management process of claim 1, wherein said assignment is a function of (a) said worker status and (b) said priority code.

3. The dynamic task management process of claim 2, wherein the assignment is influenced by a prioritization algorithm that compares the priority codes of two or more of said extracted tasks.

4. The dynamic task management process of claim 1, wherein assignment is a function of (a) a worker location and (b) a location code for said extracted task.

5. The dynamic task management process of claim 1, wherein said order is a purchase order generated by an online retail facility and said one or more tasks is one or more products ordered by an online retail customer.

6. The dynamic task management process of claim 5, wherein said workers are warehouse pickers and said tasks are warehouse picking tasks.

7. The dynamic task management process of claim 6, wherein each of said pickers has a portable digital device, and wherein:
said assignment is communicated to said picker through said portable digital device; and
said task request is communicated by the picker through said portable digital device, the task-request being sent automatically after completion by the picker of a previously assigned task request.

8. A dynamic task management system useful for mediating the exchange of task-related information between a task generator and a task performer, the management system comprising:
(a) a dynamic task manager having a task source interface, a scheduling agent, a prioritization agent, a route optimization agent, and a task performer interface, wherein
(i) said task source interface is capable of receiving tasks from said task generator,
(ii) said scheduling agent, in communication with said prioritization and route optimization agents, is capable of ordering said tasks into a master task sequence,
(iii) said prioritization agent is capable of influencing said ordering of said tasks as a function of a time-based requirement for performance of at least one of said tasks,
(iv) said route optimization agent is capable of influencing said ordering of said tasks as a function of a distance-based preference for performance of at least one of said tasks, and
(v) said task performer interface is capable of transmitting one of said tasks to said task performer in response to a task request from said task performer, said task being extracted specifically by the dynamic task manager from said master task sequence as a function of said task request; and
(b) a portable digital device in communication with said dynamic task manager through said task performer interface, the portable digital device configured for transmitting said task request to said task performer interface and for receiving the extracted task transmitted in response.

9. The dynamic task management system of claim 8, wherein the task request includes one or more of the following data: performer location, performer qualification, and performer current-activity.

10. The dynamic task management system of claim 8, wherein said task generator is an online retail facility and each of said tasks entails retrieval of one or more products ordered by a customer of said online retail facility.

11. The dynamic task management system of claim 10, wherein the task request is transmitted automatically to the dynamic task manager by the portable digital device upon completion of the retrieval of said one or more products by said task performer.

12. The dynamic task management system of claim 8, wherein the portable digital device comprises a reader for reading information-bearing media, wireless communication means for communicating with the task performer interface of said dynamic task manager, and a display for viewing tasks received from the dynamic task manager.
